(19) United States
(12) Patent Application Publication
(10) Pub. No.: US 2004/0028015 A1
(43) Pub. Date: Feb. 12, 2004

(54) Channel allocation in a communication system

(76) Inventors: Pascal Fouilland, Taourefeuille (FR); Ouelid Abdesselem, Toulouse (FR)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/433,592

(22) PCT Filed: Oct. 15, 2001
(86) PCT No.: PCT/EP01/11879

(30) Foreign Application Priority Data
Dec. 8, 2000 (EP) 00403456.7

(51) Int. Cl. H04B 7/212

(52) U.S. Cl. 370/337

(57) ABSTRACT

This application relates to channel allocation in a TDMA communication system. The invention also relates to a communication device and a communications network using the new channel allocation and to a method of receiving channels in a communication device of a communication system

This application relates to channel allocation in a TDMA communication system. The invention also relates to a communication device and a communications network using the new channel allocation and to a method of receiving channels in a communication device of a communication system.

In known and currently proposed communication systems a plurality of base stations are provided, each base station being able to communicate with mobile stations within range of the base station to provide communication services to those mobile stations.

Each communication system is allocated only a finite amount of spectrum with which to provide communication services to mobile stations. One common method of maximising the number of users the system can support is to split the available frequency spectrum into a number of different frequency carriers, and to allow different users to use the same frequency carrier at different times (so-called Time Division Multiple Access or TDMA systems).

In TDMA systems such as the well-known GSM (Global System for Mobile communications) or EDGE (Enhanced Data rates for GSM Evolution) systems, each frequency carrier carries a multi-frame comprising a number of frames divided into timeslots. In the GSM system, for example, a multi-frame comprises 51 frames, each having 8 timeslots, whereas in the EDGE system a multi-frame comprises 52 frames, each having 8 timeslots. Logic or traffic channels between a mobile station and a base station are provided by a sequence of timeslots on the same or different frequency carriers. The changing of frequency used by the channel is called frequency-hopping. A base station allocating a channel to a mobile station will inform the mobile station of the frequency law and timeslot allocation for the channel.

Typically, both the timeslot and frequency carrier will change during the sequence to reduce the impact of interference on the channel and therefore maximise the quality of the communication link. However, it is desirable to improve still further the ability of a TDMA communication system to ensure an adequate communication link quality.

It is sometimes necessary to handover a mobile station from one base station to another. If a handover of a mobile station is required when a call is ongoing, the traffic channel and associated signalling must be transferred from the original serving base station to the new target base station such that no data is lost and the handover is transparent and seamless from the point of view of the user.

In the existing GSM system, when the need for a handover is detected, the traffic channel and associated signalling are transferred from the original base station to the target base station. However, even with efficient signalling some of the traffic data may be lost during the handover. In addition if the mobile station is unable to establish the new channel with the target base station, the mobile station must reestablish a channel with the previously serving cell. During the delay to re-establish the channel traffic data will be lost, and in the worst case the call will be terminated as a result of a failed handover. This is clearly highly undesirable and so a robust handover mechanism, which is relatively simple to implement in the base station and in the mobile station of a TDMA communication system, is required.

As is well known, adverse channel conditions introduce errors into the data received on the radio interface of a wireless communication system. Various mechanisms are employed to minimise the impact of these errors on the integrity of the data. However, it is desirable to provide a new way of improving the correction of errors in data received on the radio interface of a wireless communication system.

In accordance with a first aspect of the present invention, there is provided a method of operation of a communication device in a communication system comprising using a TDMA partial rate primary channel carrying traffic and signalling information and at least one TDMA partial rate secondary channel carrying traffic information. The invention also provides a mobile station operating in accordance with this method.

In accordance with a second aspect of the present invention, there is provided a control means in a communications system, for controlling communication with a communications device using a TDMA partial rate primary channel carrying traffic and signalling information and a TDMA partial rate secondary channel carrying traffic information. Most preferably, the secondary channel carries traffic data only. However, it is possible for the secondary channel to carry signalling in addition to the traffic data.

The communications system may contain a network including first and second tranceiver means wherein the control means controls communication with the communications device using the TDMA partial rate primary channel via the first tranceiver means and the control means controls communication with the communications device using the TDMA partial rate secondary channel via the second tranceiver means.

Advantageously, the primary channel and the secondary channel carry the same information data. Preferably, however, the channel data which is actually sent on the primary and secondary channels is different owing to different puncturing schemes or channel coding schemes. It is also envisaged that the primary and secondary channel may carry different information data.

The use of two partial rate TDMA channels provides channel diversity within a TDMA system. The secondary channel can use a different set of frequencies for its frequency hopping sequence and can also use different timeslots. This diversity has the advantage that if one partial rate channel is badly affected by interference, the other partial rate channel is likely to be unaffected and thus the link between the mobile station and the network is maintained.

If the same information data is transmitted on both of the channels, the use of the two channels between the network and the mobile station maximises the likelihood that the data will get through and not be lost owing to fading or other loss in a channel. If different puncturing and coding schemes for the same information data are used, error correction of the received information is facilitated. This is particularly valuable for error correction in the mobile station of downlink primary and secondary channels.

The primary and secondary channels may be set up between the mobile station and a single base station. In this case, the first transceiver means and second tranceiver means in accordance with the second aspect of the invention are first and second tranceivers of a Base Tranceiver Station (BTS) and the control means is the associated Base Station Controller (BSC).

In addition to the advantages described above resulting from frequency or channel diversity, the use of two partial rate channels between the mobile station and a base station provides the base station with greater flexibility when making channel allocations. In particular, since the partial rate channels are separately assignable, the base station can re-assign one of the channels independently from the other.

Alternatively the two channels may be set up between the mobile station and a single base station and a relay transmitter under the control of the single base station. This arrangement is effectively identical to the situation in which the primary and secondary channels are set up between the mobile station and a single base station, but also provides space diversity by virtue of the separation between the base station and the relay. If therefore one of the channels suffers interference or fade, for example as a result of a bus moving between the mobile station and either the relay or the base station, the separation between the base station and the relay means that the other channel is unlikely to suffer interference or fading at the same time.

Additionally, the primary and secondary channels may be set up between the mobile station and each of two different base stations. This arrangement also provides space diversity in addition to the frequency diversity as outlined above.

In the second aspect of the invention, the first transceiver means and second tranceiver means may be first and second BTSs and the control means may be the BSC associated with the first BTS. If the second BTS has a second BSC associated therewith the BSC associated with the first BTS may exchange signalling information with the second BTS via the BSC associated with the second BTS.

In a particularly advantageous embodiment, the two different base stations may be at different levels in a hierarchical system arrangement.

Preferably, the partial rate channels primary and secondary channels are complementary sub-channels. The partial rate channels may be half rate channels or quarter rate channels. Clearly, if quarter rate channels are used, a third or a third and a fourth quarter rate channel may also be set up between the mobile station and one or more base stations.

Thus, for example, if two half rate channels using different sub-channel numbers are used, one channel will use all even frame numbers and the other channel will use all odd frame numbers. Thus, the mobile station can receive and transmit on both channels at the same time, by following the frequency and timeslot law allocation for the first channel on even frame numbers and following the frequency and timeslot law allocation for the second channel on odd frame numbers.

This arrangement is particularly advantageous because half-rate channels have been standardised and quarter rate channels are under standardisation. As a result the implementation of the partial rate channels using sub-channels such as half rate and quarter rate channels is simple.

In addition, the four frames carrying channel data relating to a single block of information data are now separated by frames carrying channel data relating to the other channel, instead of being sent in consecutive frames as would be conventional. As a result, additional protection is provided against errors in the decoded information data arising out of the corruption of adjacent frames on the radio interface.

It will be clear to a skilled person that it is also possible to provide partial rate channels in accordance with the invention by splitting the time division between the primary channel and the second channel differently. For example, instead of switching between the primary channel and the secondary channel on a per frame basis as described above, the mobile station might switch between the primary channel and the secondary channel on a per block (four frames) basis, a half-multiframe or a whole multiframe basis. Indeed, it should be noted that in principle the partial rate channels may carry an unequal amount of data.

In accordance with a third aspect of the present invention, there is provided a method of performing a handover of a communication device from a first base station to a second base station of a TDMA communications system, a first TDMA partial rate channel containing traffic and signalling information existing between the communications device and the first base station, the handover method comprising the steps of:

establishing a second partial rate TDMA channel between the communication device and the second base station containing traffic information only;

moving the signalling information from the first partial rate TDMA channel to the second partial rate TDMA channel;

and releasing the first TDMA channel between the communication device and the first base station.

Thus the third aspect of the invention provides an advantageous method for performing a handover in a TDMA communication system using the primary and secondary partial rate TDMA channels as outlined above. The handover method may be used both for inter-base station handover and for intra-base station handover.

During the handover, the same information data is sent on both the primary channel and the secondary channel established with the mobile station. The channel and space diversity, as outlined above, arising from the use of the primary and secondary channels during the handover results in an improved likelihood that the data will be received. In addition, since a traffic connection is maintained with both base stations while the signalling link is transferred during an inter-base station handover, the possibility that data is lost or the call is dropped is significantly reduced.

This is particularly advantageous for real-time traffic, typically voice, where delay is critical and no repetition mechanism is foreseen.

The present invention also provides a new signalling protocol and interface for use during handovers in accordance with the third aspect of the invention. In particular, a new interface between a first and a second BSC, the lur-g interface, which carries signalling and control information as well as data is defined. In addition, the signalling relating to the request and release of the secondary channel has been defined.

In accordance with a fourth aspect of the invention, there is provided a method of operation of a communication device in a communication system comprising:

receiving channel data on the first channel and obtaining first data therefrom, at least a portion of the first data being soft data;

receiving the second channel and obtaining second data therefrom, at least a portion of the first data being soft data;

combining said first and second data to obtain third data, wherein soft combining at least a portion of the data received on the first channel and the data received on the second channel to obtain third data;

and decoding the obtained third data. The invention also provides a mobile station operating in accordance with this method.

The method in accordance with a fourth aspect of the invention is particularly useful for combining information received by a mobile station from at least two different channels carrying the same information data. Although its use in a TDMA communication system with partial rate channels as outlined above is particularly advantageous, this aspect of the invention is not limited to such a system but is instead applicable to any communication system. In particular, this method is also applicable to Code Division Multiple Access (CDMA) communication systems, such as the proposed Universal Mobile Telecommunication System (UMTS).

For a better understanding of the present invention, and to show how it may be brought into effect, reference will now be made, by way of example, to the accompanying drawings, in which:

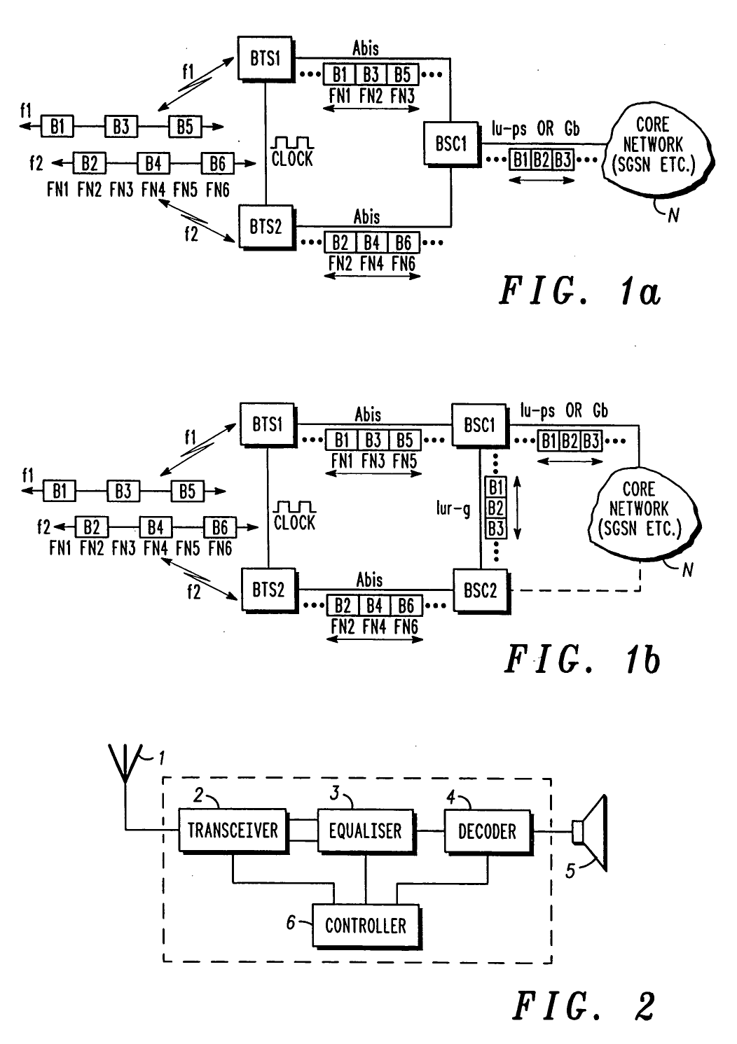

FIG. 1a illustrates the data flow between the network and a mobile station in a first arrangement in accordance with an embodiment of the invention;

FIG. 1b illustrates the data flow between the network and a mobile station in a second arrangement in accordance with an embodiment of the invention

FIG. 2 illustrates the reception and decoding elements of an exemplary mobile station;

FIG. 3 illustrates combination of received blocks on a first and second TDMA channel received at the mobile station;

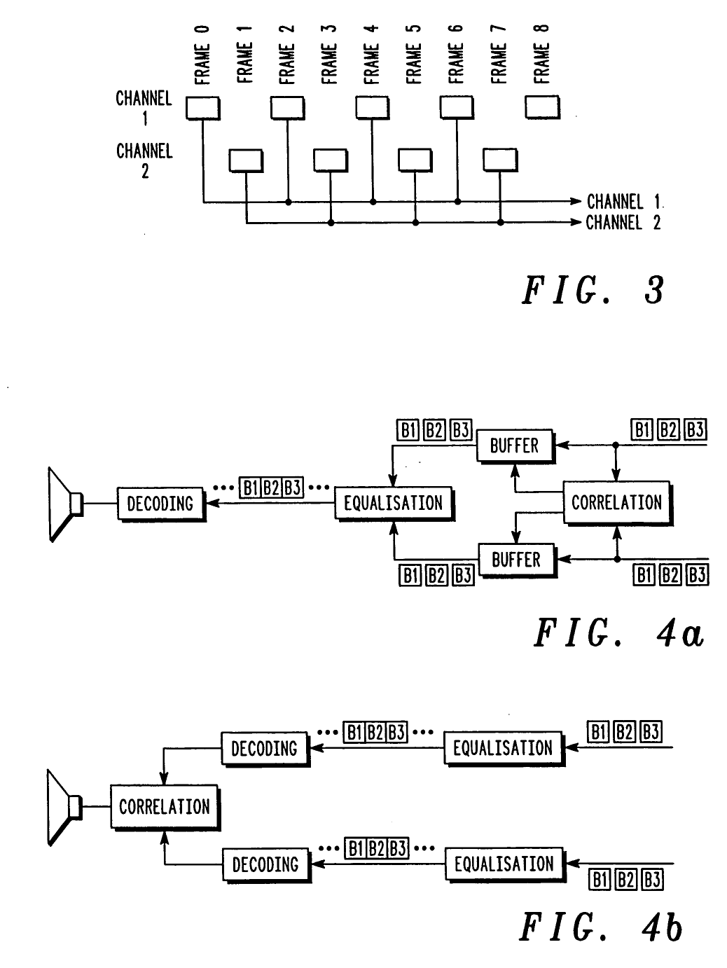

FIG. 4a is a diagramatic representation of an first alternative arrangement of the reception and decoding elements of an exemplary mobile station;

FIG. 4b is a diagramatic representation of an second alternative arrangement of the reception and decoding elements of an exemplary mobile station;

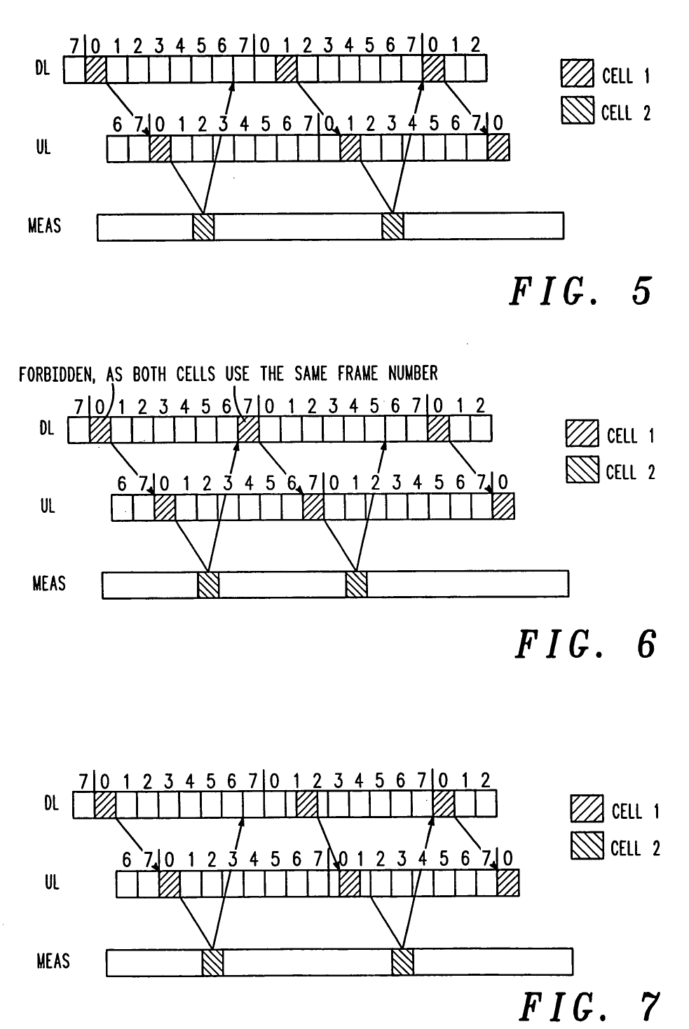

FIG. 5 illustrates a first timeslot allocation;

FIG. 6 illustrates a second timeslot allocation;

FIG. 7 illustrates a third timeslot allocation;

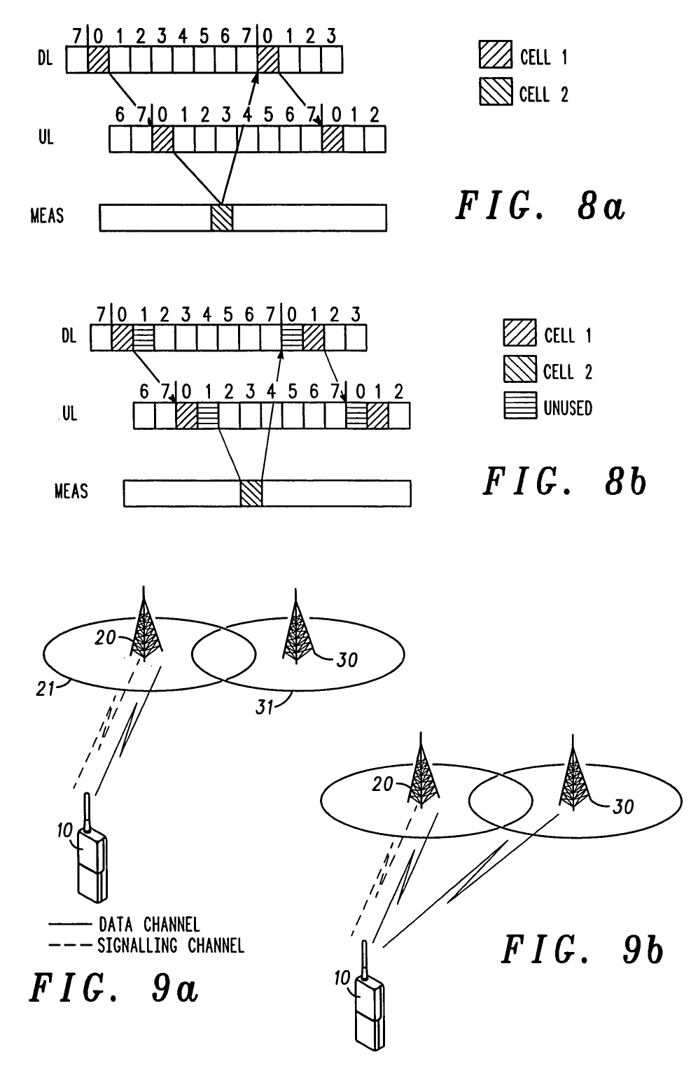

FIG. 8 illustrates a fourth timeslot allocation;

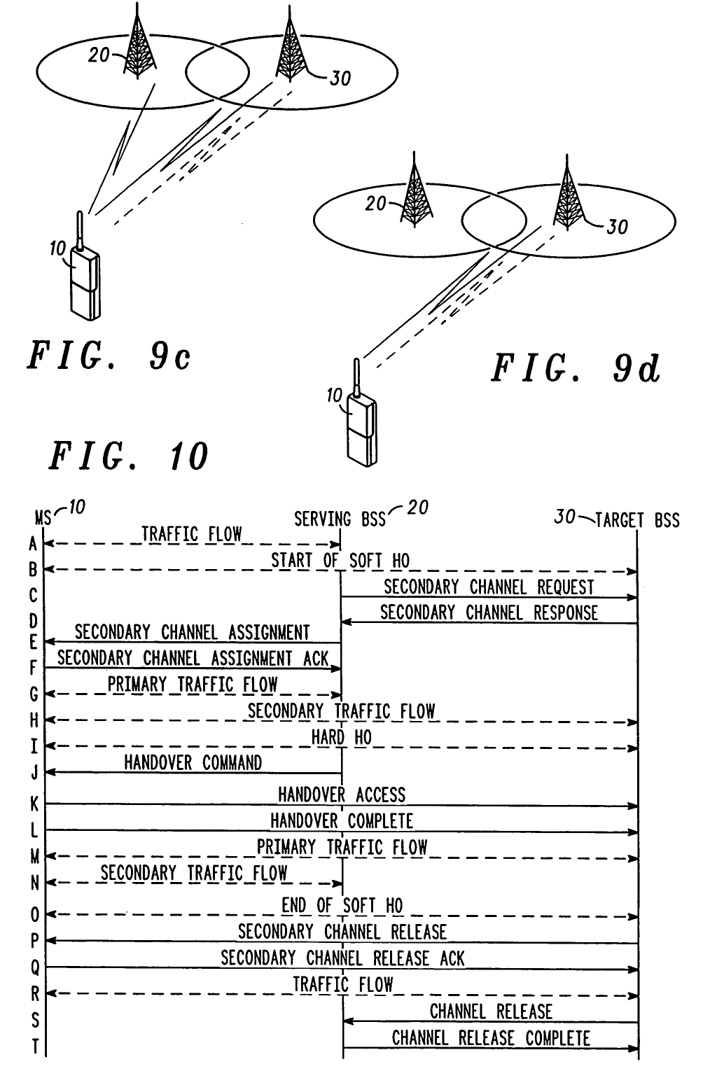

FIG. 9 shows a handover method in accordance with an exemplary embodiment of the invention;

FIG. 10 illustrates signalling and traffic flow during handover in accordance with an embodiment of the invention;

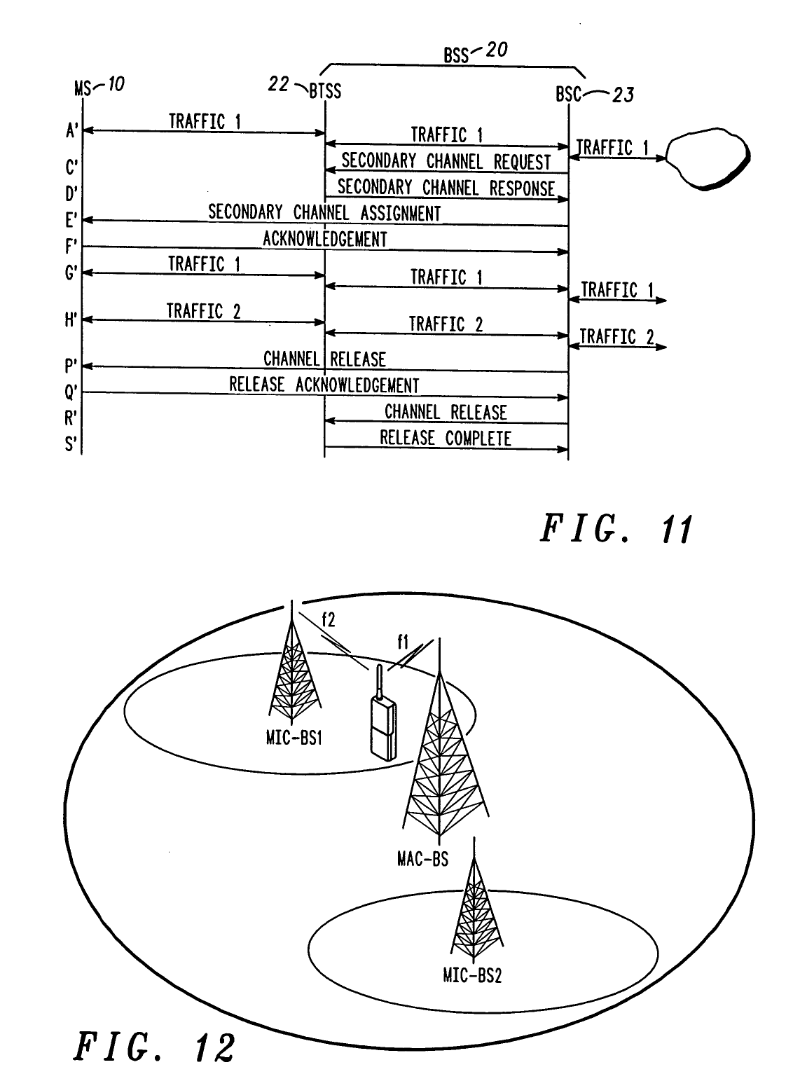

FIG. 11 illustrates signalling and traffic flow during an intra-base station handover; and

FIG. 12 illustrates the application of the invention to a hierarchical cell arrangement.

The invention will now be described with reference to the accompanying drawings in which the same or similar parts have been given the same reference numerals. Although described with reference to the GSM and EDGE systems, the described use of the primary and secondary channels and method of handover are applicable to any TDMA system. The soft combining at the mobile station is applicable to any communication system, but can advantageously be used in the described TDMA system.

The data flow between the network and a mobile station when the primary and secondary partial rate channels in accordance with the first aspect of the invention are being used will be described with reference to FIGS. 1a and 1b. In the described advantageous exemplary embodiments the same information data is being transferred between the mobile station and the network on complementary half rate channels.

FIG. 1a illustrates the data flow between the network and a mobile station when the two half rate channels are set up via first and second Base Transceiver Stations (BTS1 and BTS2) which share a Base Station Controller (BSC1). As is well known, the BSC1 communicates with a core network N over an lu-ps interface or Gb interface or over a circuit-switched interface such as an A interface or an lu-cs interface, and communicates with the BTS1 and the BTS2 over the Abis interface. The BTS1 and BTS2 are synchronised, as shown by the clock connection. BTS1 and BTS2 communicate with a mobile station (not shown) via a primary and a secondary channel f1 and f2, respectively.

FIG. 1b illustrates the data flow between the network and a mobile station when the two complementary half rate channels are set up via first and second Base transceiver stations (BTS1 and BTS2) which do not share a common Base Station Controller (BSC). In this situation, the Base Station Controllers BSC1 and BSC2 respectively associated with the Base Transceiver Stations BTS1 and BTS2 are linked by an lur-g interface. Otherwise the arrangement is the same as that shown in FIG. 1a.

As explained previously, in the illustrated embodiment the primary and the secondary channel f1 and f2 are complementary half rate channels. These channels have been set up as complementary half rate channels under the control of the primary BSC1, either directly (in the case of both f1 and f2 in FIG. 1a as well as f1 in FIG. 1b), or indirectly (transparently via BSC2) in the case of FIG. 1b. As is clear from a consideration of FIGS. 1a and 1b, the complementary half rate channels f1 and f2 are allocated alternate frames of a multiframe.

Three information data blocks B1, B2 and B3 are shown for reference. As shown in FIGS. 1a and 1b, BSC1 receives information data blocks from, and transmits information data blocks to the core network N over the lu-ps or the Gb interface, or over a circuit-switched interface such as the A interface or the lu-cs interface. BSC1 sends the information data blocks to, or receives the information data blocks from BTS1 and BTS2. In the arrangement shown in FIG. 1a, the information data blocks are transmitted directly across the respective Abis interface. In the arrangement shown in FIG. 1b the information data blocks to or from BTS1 are transmitted across the Abis interface and the information data blocks to or from BTS2 are transmitted transparently by the BSC2 across the Abis and the lur-g interfaces.

For downlink data BTS1 and BTS2 perform channel coding and any puncturing that is being applied, in accordance with conventional techniques that will be known to a skilled person, before transmitting the resulting channel information on the half rate sub-channels f1 and f2, respectively. Although, as described above, the same information data block is transmitted to the mobile station via channel f1 and via channel f2, different puncturing schemes and/or coding schemes may be used in the two channels. This difference in the channel data actually transferred on the two channels can provide additional information which can be used to correct errors in the received data.

For uplink data the channel data received at BTS1 and BTS2 on channels f1 and f2 respectively is decoded and the resulting information data is passed to BSC1 (over the Abis interface or transparently through the BSC2 via the Abis and lur-g interface) and then on to the network N. Since one or other of the channels f1 and f2 may suffer from interference from time to time, the BSC1 can use the data from the other channel to ensure faithful transfer of the data.

In the described embodiment the radio blocks are synchronised on a frame number basis as the channels can be received more easily. However, this is not essential to synchronise the radio blocks in this way.

Of course, it would also be possible to transmit alternate blocks on each of the two complementary sub-channels f1 and f2. Clearly, this would double the capacity of the link to the mobile station compared with the embodiment described above, although at the expense of the robustness provided by the above-described method.

Although the mobile station has two channels established only one of the channels carries associated signalling or control information. As a result, the mobile station can only receive power control information from, and report power measurements to, the base station with which a signalling link is established. This would mean that in the event that there is a significant difference between the reception paths from the two cells, the mobile station would receive data blocks from only the serving cell, with which a signalling link is established.

In a similar way, the timing advance is controlled by the serving cell base station. Since the two cells are synchronised, the mobile station is able to evaluate the timing difference between them by monitoring the delay between the downlink paths. The mobile station can use this information to calculate the timing advance to be used towards the other BTS.

The operation of the mobile station when receiving two channels carrying the same information data, in accordance with an embodiment of the fourth aspect of the present invention, will now be described with reference to FIG. 2, which shows the reception and decoding elements of a mobile station.

The reception and decoding elements of the mobile station shown in FIG. 2 has an antenna 1 for receiving signals from a communication network. The antenna 1 is connected to a transceiver 2. The receive portion of the transceiver 2 is coupled to an equaliser 3, which in turn is coupled to a decoder 4. The output of the decoder is then output 5 for use by the mobile station, for example to be output as speech. A controller 6 controls the operation of the reception and decoding elements of the mobile station. Parts which are not relevant to the description of the invention have been omitted, as these will be clear to a skilled person.

In order for the mobile station to receive a first and a second channel, the controller 6 controls the transceiver to receive first and second channel data on the first and the second channel respectively. The first and second channel data is passed to the equaliser 3 which channel decodes the received channel data and soft combines the resulting symbols.

For soft combining of the received data an indication of the reliability of the decoded data is provided as well as the data itself. As the mobile station is receiving the same data via the two channels, the more reliable data can be retained and the less reliable data can be discarded. The use of different puncturing schemes for the two channels will result in the reception in the mobile of two different channel data sets corresponding to the same information data, and this additional information may further assist decoding and error correction in the mobile.

The implementation of this aspect of the invention in a TDMA communication system, for example in which complementary half rate channels in accordance with the described exemplary embodiment are used, is particularly advantageous, as is illustrated FIG. 3.

If the transmitted radio blocks are not synchronised on a block by block basis, it is necessary for the mobile station to correlate the radio blocks received on the different channels. This correlation can be performed before the equalisation, in order to perform soft combining, or after voice decoding. These arrangements are shown in FIGS. 4a and 4b.

In order to avoid a requirement for two transceivers in the mobile station, the timeslot (TS) allocations for the complementary sub-channels f1 and f2 should enable the mobile station to alter its uplink and downlink timeslot allocation from frame to frame so as to receive and transmit on both sub-channels. As will be known to a person skilled in the art, the timeslot combinations which can be used by a mobile station depend on the multislot class of the mobile station, since the multislot parameters (Tta, Ttb, Tra, and Trb) associated with the multi-slot class must be adhered to in order to enable the mobile station to move its time reference between adjacent frames.

The available channel allocations for cell 1 and cell 2 are:

for multislot class 1, the same timeslot N shall be used

for multislot classes 2-7, timeslot N or N+/−1 shall be used

for multislot classes 8-11, timeslot N, N+/−1 or N+/−2 shall be used

for multislot class 12, timeslot N, N+/−1, N+/−2 or N+/−3 shall be used.

For example, a multislot class 2 mobile station (ie capable of a maximum of 2 Rx channels and one Tx channel) might have timeslot TS0 allocated on cell 1 and timeslot TS1 allocated on cell 2, as shown in FIG. 5.

However, it should be noted that the timeslot allocation possibilities are limited by the requirement that the timeslots relating to the channel allocated in cell 1 must always be in a different frame from the timeslots relating to the channel allocated in cell 2. Thus an allocation such as that shown in FIG. 6, which would otherwise satisfy the allocation requirement as set out above, is impermissible.

It should be noted that the difference on the timing advance to be used on the target cell and the serving cell does not impact the Tra parameter (ie the time to perform measurements and be ready to receive, as is clear from FIG. 7).

Alternatively, timeslots can be allocated with the same constraints as if they were both allocated to a single cell. Thus, a mobile station supporting 1 Tx slot (multislot class 1-4) shall have the same TS allocated on both cells. An example for a multi-slot class 1 mobile is shown in FIG. 8a. A multislot class 5 MS may have TS0 allocated on the serving cell and TS1 allocated on the target cell, as if TS0 and TS1 were continuously allocated as shown in FIG. 8b.

A handover method in accordance with an exemplary embodiment of the invention will now be described with reference to FIG. 9. In accordance with the first embodiment of the present invention, a mobile station 10 in an existing call with the base station 20 of the serving cell 21 (FIG. 9a) is communicating with the serving base station 20 using a partial rate channel (half rate channel or quarter rate channel) which carries both traffic and signalling information.

In the most preferred embodiment of the invention the existing channel is a partial rate channel, for example a half rate channel. However, the situation in which the existing channel is a full rate channel which is changed to a half rate channel at the start of the handover in accordance with this embodiment of the invention is also envisaged.

As the mobile station 10 approaches the cell boundary of the serving cell 21, a second partial rate channel (for example quarter rate channel or half rate channel) is set up with the base station 30 of the target cell 31 (FIG. 9b). The new partial rate channel set up with the base station 30 of the target cell carries only traffic information.

As the mobile station 10 moves into the target cell 31 the signalling link is switched from the initially serving cell 21 to the target cell 31 (FIG. 9c). Thus, the partial rate channel between the mobile station 10 and the base station 30 of the target cell now carries signalling and traffic information, and the partial rate channel between the mobile station 10 and the base station 20 of the initially serving cell carries only traffic information.

Finally, once the mobile station 10 moves further into the target cell 31 the partial rate channel between the mobile station 10 and the initially serving base station 20 is relinquished, and the handover is complete (FIG. 9d).

The signalling and traffic flow between the mobile station 10, the serving base station 20 and the target base station 30 during the handover in accordance with the embodiment of the invention will now be described with reference to FIG. 10.

With reference to FIG. 10, initially the mobile station 10 is communicating with the serving base station 20 using a partial rate channel (half rate channel or quarter rate channel) which carries both traffic and signaling information (step A). This situation corresponds to the situation shown in FIG. 9a. When a handover requirement is determined (step B) the serving base station 20 requests the target base station 30 to allocate a secondary channel to the mobile station 10 (step C). As indicated previously, in accordance with the exemplary embodiment of the invention the secondary channel allocated by the target base station 30 is a partial rate channel. This new partial rate secondary channel carries only traffic information: the signalling link is maintained with the initially serving base station 20.

Once the serving base station 20 receives the secondary channel request response from the target base station 30 (step D) the serving base station 20 informs the mobile station 10 of the secondary channel assignment ie the timeslot, frequency law and sub-channel number for the secondary channel (step E). The mobile station 10 acknowledges the secondary channel assignment to the serving base station 20 (step F). Thereafter the mobile station 10 exchanges traffic information with the serving base station 20 on the primary channel (step G) and exchanges traffic information with the target base station 30 on the secondary channel (step H). This situation is the same as that depicted in FIG. 9b.

This situation may continue until the mobile station 10 moves into the target cell 31 and the signalling link is switched from the initially serving cell 21 to the target cell 31 as shown in FIG. 1c. At the start of hard handover (step I), the serving base station 20 sends a handover command to the mobile station 10 (step J). In response to the handover command, the mobile station 10 sends a handover access request to the target base station 30 (step K) followed by a handover complete message (step L). At this point the signalling control link is moved from the originally serving base station 20 to the target base station 30. The mobile station 10 exchanges traffic information with the target base station 30 on the primary channel (step M) and exchanges traffic information with the originally serving base station 30 on the secondary channel (step N).

At the end of the handover (step O) the target base station sends a secondary channel release message to the mobile station (step P). On receipt of this message, the mobile station 10 acknowledges the secondary channel release (step Q) and releases the secondary channel (carrying traffic only) with the originally serving base station 20. Once the target base station 30 has received the secondary channel release acknowledgement, the target base station 30 informs the originally serving base station 20 of the channel release (step S). Once the secondary channel release acknowledgement is received from the originally serving base station (step T) the handover is complete. This corresponds to the situation in FIG. 9d.

Of course, if a full rate channel is desired between the mobile station and the new serving base station 30 this can be achieved with conventional signaling and channel reassignment.

Although handover between a first base station 20 and a second base station 30 has been described, it is not necessary for the handover to occur between two base stations. In an alternative embodiment of the invention described with reference to FIG. 11, an intra base-station handover can be achieved. In FIG. 11 a mobile station 10 is in an established call with a serving base station 20, comprising a BTS 22 and a BSC 23.

Initially a primary traffic channel is established between the mobile station 10 and the BTS of the base station and this traffic information is routed through the BSC 23 to the network N (step A′). In order to perform an intra base station handover, the BSC 23 requests a secondary channel assignment from the BTS 22 (step C′). Once the BSC is notified of the secondary channel (step D′) the BSC 23 informs the mobile station 10 of the secondary channel assignment (step E′). Once the secondary channel assignment has been cknowledged by the mobile station (step F′), the secondary traffic path to the network N is set up through the BTS 22 and the BSC 23 (step H′) in addition to the existing primary traffic path (G′).

In order to complete the intra base station handover, a channel release message is sent from the BSC 23 to the mobile station 10 (step P′). Once the mobile station acknowledges the channel release message (step Q′) the BSC 23 informs the BTS 22 of the cannel release (step S′). Once the channel release is acknowledged, (step T′) the intra-base station handover is complete.

Equally, although the establishment of the primary and secondary channels have been described in the context of a handover between one base station and another or in the context of intra-base station handover, in an alternative advantageous embodiment of the invention parallel primary and secondary channels may be established with one or more base stations during normal operation and not necessarily during a handover. The setting up of the primary and secondary channels in this situation is similar to that described above with reference to FIGS. 10 and 11, with the omission of the steps relating to the detection of a handover condition, the transfer of the signalling link from one base station to another (in the inter-base station handover situation described with reference to FIG. 10) and the subsequent release of one of the channels.

The use of the invention is particularly advantageous in a hierarchical cell situation, in which, for example, the areas covered by several micro or pico-cells fall wholly or partly within the area covered by a macro-cell. FIG. 12 shows such an arrangement, where the macro-cell is served by a macro-cell base station (MAC-BS) and a micro-cell is served by a micro-cell base station (MIC-BS1 and MIC-BS2). Problems in providing adequate coverage to a mobile station 10 in such situations is well known. A solution in accordance with an embodiment of the invention is to establish a partial rate link with the base station of the macro cell (MAC-BS) and a second partial rate link with the base station of the micro cell (MIC-BS1). As the mobile moves within the macro cell the partial rate link to the macro-cell base station (MAC-BS) is maintained and the partial rate channel to the base station of the micro cell (MIC-BS1) is handed over to the base station of another micro cell (MIC-BS2). Thus a traffic channel is always maintained with the macro-cell leading to improved performance of the system owing to the reduced likelihood that the call will be dropped as the mobile station moves between cells.

In addition, the allocation of two partial rate channels between a mobile station 10 and its serving base station provides useful frequency diversity. Allocation of one of the partial rate channels can be changed using the intra base station handover described above with reference to FIG. 11 in order to select the optimum channel (with minimum interference) and so provide the best service to the mobile station.

In order to achieve space diversity as well as frequency diversity, a base station and associated relay, such as shown in FIG. 12 may advantageously be used.

Thus, aspects of the present invention provide channel/frequency diversity as well as space diversity provide improved quality, in particular during handover as no speech samples will be lost. Capacity gains can be realised from using two HR or OR channels instead of one FR channel under medium or bad radio conditions. The vunerability of these channels will be compensated by the double path towards two cells.

1. A method of operation of a communication device in a communication system comprising using a TDMA partial rate primary channel carrying traffic and signalling information and at least one TDMA partial rate secondary channel carrying traffic Information wherein the primary channel and the secondary channel carry the same information data.

2. A method of operation of a communication device as claimed in claim 1 wherein the channel data sent on the primary and secondary channels Is different owing to different puncturing schemes or channel coding schemes.

3. A method of operation of a communication device as claimed in claim 1 or 2 wherein the TDMA partial rate channels are complementary TDMA sub-channels.

4. A method of operation of a communication device as claimed in claim 3 wherein the TDMA partial rate channels are half rate channels.

5. A control means in a communications system, for controlling communication with a communications device using a TDMA partial rate primary channel carrying traffic and signalling information and a TDMA partial rate secondary channel carrying traffic information wherein the primary channel and the secondary channel carry the same information data.

6. A control means in a communications system as claimed in claim 5 wherein the channel data sent on the primary and secondary channels is different owing to different puncturing schemes or channel coding schemes.

7. A control means in a communications system as claimed in claims 5 or 6 wherein the TDMA partial rate channels are complementary TDMA sub-channels.

8. A control means in a communications system as claimed claim 7 wherein the TDMA partial rate channels are half rate channels.

9. A communications network in a communication system including first and second tranceiver means and a control means as claimed in one of claims 5-8.

10. A communications network in a communication system as claimed in claim 9 wherein the first transceiver means and second tranceiver means are first and second tranceivers of a Base Tranceiver Station (BTS) and the control means is the associated Base Station Controller (BSC).

11. A communications network in a communication system as claimed in claim 9 wherein the first transceiver means and second tranceiver means are first and second BTSs and the control means is the BSC associated with the first BTS.

12. A communications network in a communication system as claimed in claim 11 wherein the second BTS has a second BSC associated therewith the BSC associated with the first BTS exchanges signalling information with the second BTS via the BSC associated with the second BTS.

13. A communications network in a communication system as claimed in claim 11 or 12 wherein the two different base stations may be at different levels in a hierarchical system arrangement.

14. A method of performing a handover of a communication device from a first base station to a second base station of a TDMA communications system, a first TDMA partial rate channel containing traffic and signalling information existing between the communications device and the first base station, the handover method comprising the steps of: establishing a second partial rate TDMA channel between the communication device and the second base station containing traffic Information only, the first TDMA partial rate channel and the second partial rate TDMA channel carrying the same information data; moving the signalling information from the first partial rate TDMA channel to the second partial rate TDMA channel; and releasing the first TDMA channel between the communication device and the first base station.

15. A method of performing a handover as claimed in claim 14 wherein the channel data sent on the primary and secondary channels is different owing to different puncturing schemes or channel coding schemes.

16. A method of performing a handover as claimed in claim 14 or 15 wherein the TDMA partial rate channels are complementary TDMA sub-channels.

17. A method of performing a handover as claimed in claim 16 wherein the TDMA partial rate channels are half rate channels.

18. A method of operation of a communication device in a communication system comprising: receiving channel data on a first TDMA partial rate channel and obtaining first data therefrom, at least a portion of the first data being soft data; receiving channel data representative of the same information data on a second TDMA partial rate channel and obtaining second data therefrom, at least a portion of the second data being soft data; combining said first and second data to obtain third data, wherein soft combining at least a portion of the data received on the first channel and the data received on the second channel to obtain third data; and decoding the obtained third data.

19. A method of operation of a communication device in a communication system comprising: receiving channel data on the first channel and obtaining first data therefrom, at least a portion of the first data being soft data; receiving the second channel and obtaining second data therefrom, at least a portion of the first data being soft data; combining said first and second data to obtain third data, wherein soft combining at least a portion of the data received on the first channel and the data received on the second channel to obtain third data; and decoding the obtained third data.

20. A method of operation of a communication device as claimed in claim 19 where the first and second channels are TDMA partial rate channels

21. A method of operation of a communication device as claimed in claim 18 or 20 wherein the TDMA partial rate channels are complementary TDMA sub-channels.

22. A method of operation of a communication device as claimed in claim 18 or 20 wherein the TDMA partial rate channels are half rate channels.

23. A method of operation of a communication device as claimed in claim 19 wherein the first and second channels are CDMA channels.

24. A method of operation of a communication device as claimed in any one of claims 18-23 wherein the channel data sent on the primary and secondary channels is different owing to different puncturing schemes or channel coding schemes.

25. A communication device adapted to operate in accordance with the method of operation as claimed in one or more of claims 1-4 and 18-24.
